(19) United States
(12) Patent Application Publication
(10) Pub. No.: US 2016/0239806 A1
(43) Pub. Date: Aug. 18, 2016

(54) EMPLOYMENT MATCHING SYSTEM AND DEVICES

(71) Applicant: Blazejobs, LLC, Edmond, OK (US)

(72) Inventors: Lydia Benham, Edmond, OK (US); David Benham, Edmond, OK (US)

(21) Appl. No.: 15/044,982

(22) Filed: Feb. 16, 2016

Related U.S. Application Data
(60) Provisional application No. 62/115,863, filed on Feb. 13, 2015.

(51) Int. Cl. G06Q 10/10

(52) U.S. Cl. CPC G06Q 10/1053

(57) ABSTRACT

A system for matching a job seeker with an employer. The system includes a first mobile device and second mobile device. Each device may include a location detection module, a user interface, a network connection module, a processor and a data storage medium that includes executable instructions and system data. The executable instructions are structured to direct the processor to present interactive screens on the user interface. Through the navigation of such screens, a job seeker can identify job posts of interest, apply for jobs, schedule interviews, and request recommendations from referral sources.

### RELATED APPLICATIONS

This application claims the benefit of a provisional application, Application No. 62/115,863 filed on Feb. 13, 2015.

### FIELD OF THE INVENTION

This invention relates generally to the field of employment, and more particularly, but not by way of limitation, to a system of mobile applications designed to help job seekers locate jobs and help companies fill open positions.

### BACKGROUND OF THE INVENTION

Traditional job seeking methods are comprised of looking for hiring signs in business windows, endorsements and referrals from colleagues and friends, looking online or using job fairs or career service aids. All of these are vastly outdated in process and only have one single onboarding process for every type of job position.

These processes are cumbersome, contribute to high turnover, and involve having most of the resume exchanges or application questionnaires not be relevant to the entry level demographic of the targeted job seekers.

The disadvantage of traditional systems begin with the requirement that the process begins with an in-person initiating event, with job seekers making the assumption that employees can stop what they are doing to speak with them. The disadvantages continue with the requirement and reliance on paper applications, which require tracking and are often lost or misplaced before reaching hiring manager. Further, traditional systems are needlessly length, and require the job seeker to sit around waiting to hear a response all under the assumption that the previous steps were completed correctly.

The most significant problem with traditional hiring systems, however, is that current lifestyles are not conducive to showing up to apply in-person for jobs anymore. The modern work force is constantly moving and people are inundated with personal schedules, other commitments, as well as other full or part-time jobs. Employers miss qualified job seekers because of the traditional—but lengthy—processes of posting job posts and filtering them through online employment boards, which require the job seeker to submit a resume and/or completing an application, bring the job seeker in for an in person interview and going through the hiring process. Setting aside these apparent inefficiencies, the economics of the process are stacked against the job seeker and the would-be employer, as the amount of time it takes on both the employer and job seeker's side is unbalanced when compared to the potential wage earned for entry-level job positions.

All of these inefficiencies lead some to conclude that there are “simply no jobs available,” when in fact the opposite may be true. This problem could be attributable to a generational gap between management and the current generation of first-time job seekers that are constantly on their phones and online. Put simply, these job seekers are not looking in classifieds or driving around searching for Now Hiring signs. Job Seekers are either college-age students looking for temporary positions, or specific or unskilled workers looking for the next opportunity. These users are looking for an easy, efficient way to find suitable opportunities that meet their location requirements (close to home, etc.), hours required, availability and pay. They cannot afford to waste time driving around looking for ‘Now Hiring’ signs, showing up for multiple interviews, or trying to determine the pay or hours.

Referrals are a good source of job seekers but similar to putting a ‘Now Hiring’ sign in your location, but to be successful the referral source must also be vetted.

While many online or in-house hiring resources have dashboards to track and give updates on job seekers or job posts for employers, they are not able to access this information on the go. Employers in this market wear multiple hats and are not able to login to a desktop application to check on how close they are to filling a desperately needed position. They need something that renders well on a small screen and can give them a status report in seconds via wireless or Wi-Fi connection.

It is to these problems that the present invention is directed.

### SUMMARY OF THE INVENTION

Described herein is an employment matching system. The preferred embodiment of this system includes a job seeker mobile device, an employer mobile device, and a central system server. The job seeker mobile device includes a location detection module, a user interface, a processor, a network connection module and a data storage medium. Each of these components of the job seek mobile device may be configured to communicate with each other. The data storage medium preferably includes executable instructions that direct the processor to display certain screens on the user interface. Based upon selection on the those screens, information and data may be generated that are stored by the processor as system data in the data storage medium. The screens displayed on the user interface can generally be categorized into job seeker screens and employer screens, although some screens may be used by both job seekers and employers. In the preferred embodiment of the employment matching system, the employer mobile device include the same components as described above for the job seeker mobile device. It will be understood that other embodiments are possible and included within the description provided below.

### BRIEF DESCRIPTION OF THE DRAWINGS

FIG. 1 displays an employment matching system.

FIG. 2 displays an architecture for a mobile device.

FIG. 3 displays a home screen that showing a map and list of jobs near a job seeker.

FIG. 4 displays a screen that allows navigation of an employment matching system.

FIG. 5 displays a screen for creation of a job seeker profile.

FIG. 6 displays a screen for entering prior job experience.

FIG. 7 further displays a screen for entering prior job experience.

FIG. 8 further displays a screen for entering prior job experience.

FIG. 9 further displays a screen for entering prior job experience.

FIG. 10 displays a screen for viewing of job matches.

FIG. 11 displays a screen for viewing details regarding a posted position.

FIG. 12 displays a screen for viewing pending and accepted interview times.

FIG. 13 displays a screen for accepting or rejecting pending interview times.

FIG. 14 displays a screen for reading, sending, or deleting messages.

FIG. 15 further displays a screen for reading or sending messages.

FIG. 16 displays a screen for viewing jobs the job seeker has made favorites.

FIG. 17 displays a screen for viewing or requesting vouches, and finding friends.

FIG. 18 displays a screen for viewing new vouches.

FIG. 19 displays a screen for viewing vouch requests.

FIG. 20 displays a screen for viewing, accepting or declining vouch details.

FIG. 21 displays a screen for viewing friends.

FIG. 22 displays a screen for asking for a vouch.

FIG. 23 displays a screen entering criteria to search for job posts.

FIG. 24 further displays a screen entering criteria to search for job posts.

FIG. 25 further displays a screen entering criteria to search for job posts.

FIG. 26 further displays a screen entering criteria to search for job posts.

FIG. 27 further displays a screen entering criteria to search for job posts.

FIG. 28 displays a home screen for an employer.

FIG. 29 displays a screen that allows navigation of an employment matching system.

FIG. 30 displays a screen for creation of an employer profile.

FIG. 31 displays a screen for creation of a company profile.

FIG. 32 displays a screen for creation of job posts, deletion of job posts, or the turning on or off of job posts.

FIG. 33 displays a screen for adding or editing information regarding a job post.

FIG. 34 further displays a screen for adding or editing information regarding a job post.

FIG. 35 displays a screen for viewing employee matches for job posts.

FIG. 36 further displays a screen for accessing job seeker profiles through the screen in

FIG. 35.

FIG. 37 displays a screen of an employer's view of a job seeker's profile, wherein the employer may view vouches, send messages, request video interviews, or make a job seeker a favorite once the employer accesses the job seeker profile.

FIG. 38 displays a screen of vouches for a job seeker.

FIG. 39 displays a screen for proposing an interview.

FIG. 40 displays a screen for an employer to view or cancel upcoming interviews, or to view or cancel proposed interviews.

FIG. 41 displays a screen for starting a interview.

FIG. 42 displays a screen of a interview.

FIG. 43 displays a screen of job seekers who have massaged the employer.

FIG. 44 displays a screen that allows viewing or creation of messages by the employer.

FIG. 45 displays an employer's saved job seeker screen.

FIG. 46 is a flow chart depicting the job seeker's navigation.

FIG. 47 is a flow chart depicting the employer's navigation.

### DETAILED DESCRIPTION OF PREFERRED EMBODIMENTS

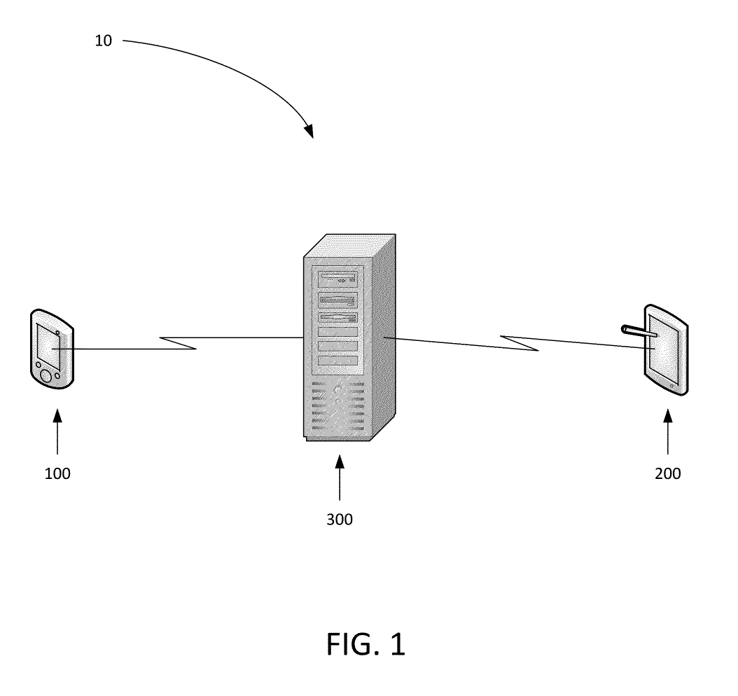

The employment matching system 10 includes a job seeker mobile device 100, an employer mobile device 200 and a central system server 300. FIG. 1 depicts the preferred configuration of the employment matching system 10 wherein the job seeker mobile device 100 and employment mobile device 200 are in electronic communication with the central system server 300. It will be understood by those skilled in the art that in the preferred embodiment depicted in FIG. 1, the job seeker mobile device 100 and employment mobile device 200 each are configured to transmit and receive a variety of data to the central system server 300, which may in turn transmit and receive such data to the employment mobile device 200 and job seeker mobile device 100 respectively. It will be understood that while FIG. 1 depicts a single job seeker mobile device 100 and single employer mobile device 200, other embodiment of the system many include pluralities of each, who architecture may also vary from each other.

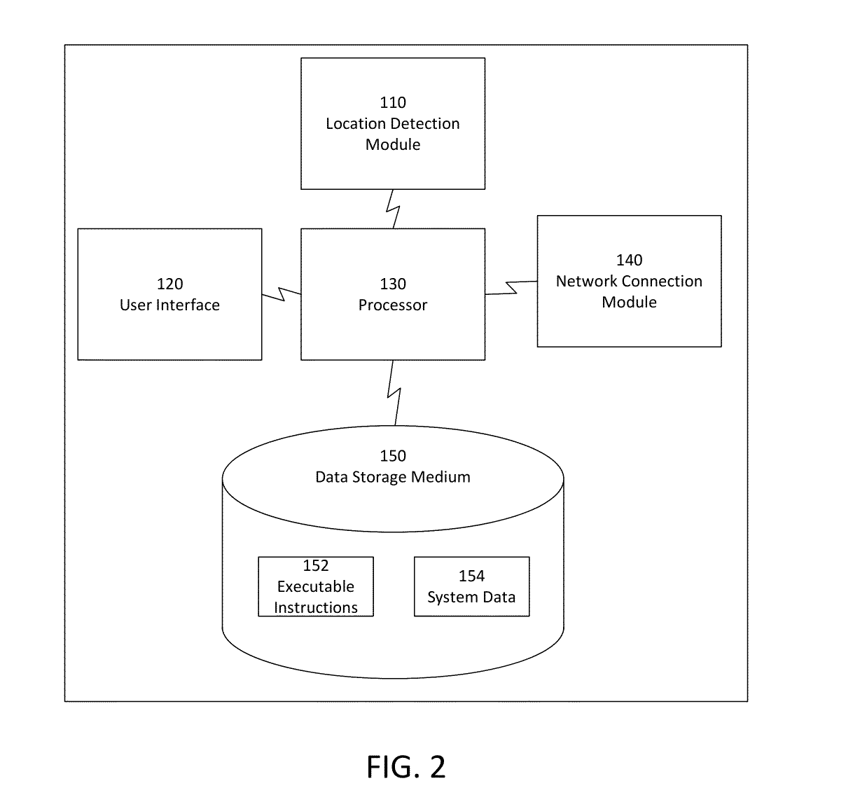

Turning to FIG. 2, shown therein is a preferred architecture for both the job seeker mobile device 100 and the employer mobile device 200. While this preferred architecture is described in terms of the job seeker mobile device 100, it will be understood that the same architecture can be employed by the employer mobile device 200. This preferred mobile device architecture includes certain components, namely, a location detection module 100, a user interface 120, a processor 130, a network connection module 140, and a data storage medium 150. In other embodiments, the architecture of the job seeker mobile device 100 may differ from that of the employment mobile device 200. Indeed, multiple configurations are available.

The processor 130 functions as a central processing unit for the job seeker mobile device 100, and is therefore in communication with the location detection module 110, the user interface 120, the network connection module 140 and the data storage medium 150. In will understood that through such communication with the other components of the job seeker mobile device 100, the processor 130 can monitor and control the functions of those components. The particular actions of the processor 130 are directed by executable instructions 152, which are stored on the data storage medium 150. It will be understood that the executable instructions 152 are configured to direct the operations of the processor 130 and its interactions with each of the other components of the job seeker mobile device 100.

The location detection module 110 is configured to ascertain and detect the geographic location of the job seeker mobile device 100. This may be accomplished by utilizing the global positioning system, by detecting the proximity of nearby wireless signals (wife-networks) and comparing that to a database of geographic locations for such signals and networks, or by a combination of other known location detection techniques. The location detection module 110 is further configured to communicate this location to the processor 130.

The network connection module 140 is configured to connect to a network, and to facilitate communication over that network between the job seeker mobile device 100 and the central system server 300. In the preferred embodiment, the network connection module is capable of connecting to existing wireless data networks (LTE, 3G, etc.), wi-fi, bluetooth or other wireless technologies known in the art. The network connection module 140 is further configured to send and receive messages to and from the central system 300, the employer mobile device 200, or other mobile devices used in the employment matching system 10 (such as other employer mobile devices 200 and other job seeker mobile devices 100).

The user interface 120 is preferably a touch screen display commonly used an input and output in connection typical smart phones and tablets available in the market. The user interface 120 is configured to display certain screens (described below) which present information related to the employment matching system 10. The particular screen displayed by the user interface 120 at any given time is determined by the processor 130 as directed by the executable instructions 152. The user interface 120 is also configured to receive input, preferably via touch sensors in the user interface 120. In this manner a user can indicate desired operations by touching certain user interface elements of the screens displayed on the user interface 120. The particular user interface elements selected are communicated by the user interface 120 to the processor 130. As a result, the processor 130, as directed by the executable instructions 152, may direct that a different screen be displayed on the user interface 120, that a message be sent to the central system server 300, that certain data be stored as system data 154 on the data storage medium 154, or other operation and functions required by the employment matching system 10, as described herein.

As previously discussed, the data storage medium 150 includes executable instructions 152 and system 154. The executable instructions 152 are operable instructions that can be read and processed by the processor 103. The executable instructions 152 include instructions for the display of certain screens on the user interface 120 (as described below), and include processes and methods that determine to store and retrieve certain system data 154 on the data storage medium 154. For the aid of understanding the executable instructions 152 may be considered as defining a mobile application consisting of screens and business logic that present screens on the user interface 120 and permit the interactions described below. The system data 154 may include information such as a job seeker's name, address, skills, job history, availability, current location, messages, scheduled interview time slots, an employer's name, company, title, biographical information, location, positions available, job post title, job post description, messages, interview time slots, and other information related to the employment matching system 10. It will be understood that the data storage medium 150 may consist of various existing random access memory structures or any other memory structures currently available.

It will be further understood that FIG. 2 depicts a logical architecture for the job seeker mobile device 100 in order to aid the understanding of the structure of the job seeker mobile device 100. Thus, while a particular component may be described as performing a certain function or operation, that function or operation can be performed by a different physical component in an alternative embodiment. For example, in certain embodiments, the processor 130 may perform some of the tasks and operations of the location detection module 110, or the network connection module 140.

As explained above, the configurations disclosed in FIGS. 1 and 2 allow information to be stored and transmitted from job seeker's device to the employer's device or from the employer's device to the job seeker's device. When information is presented to an employer based on information the job seeker has entered or information is presented to a job seeker based on information the employer has entered, FIGS. 1 and 2 as described above encompass the preferred embodiments that allows the transmission of this information.

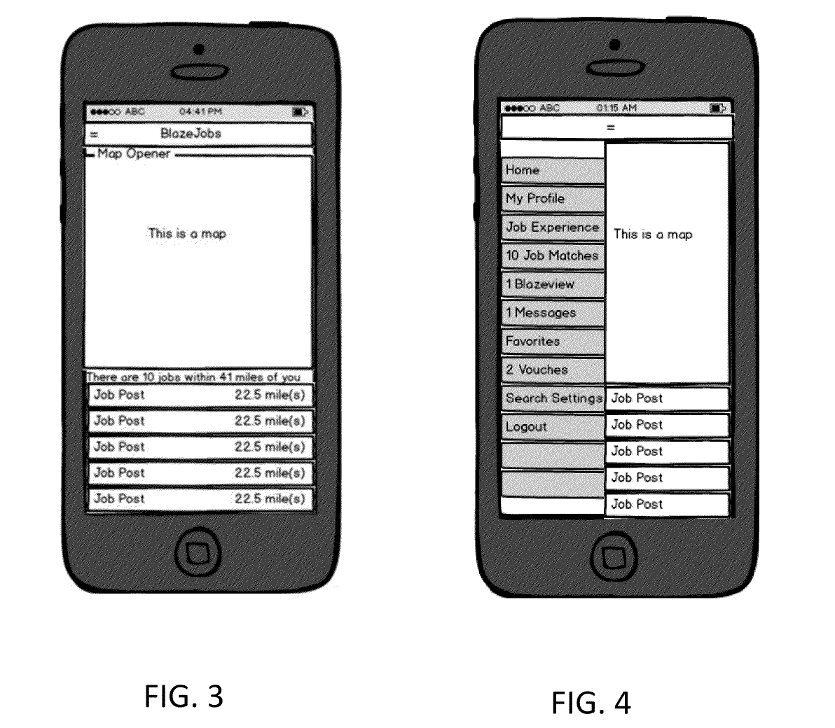

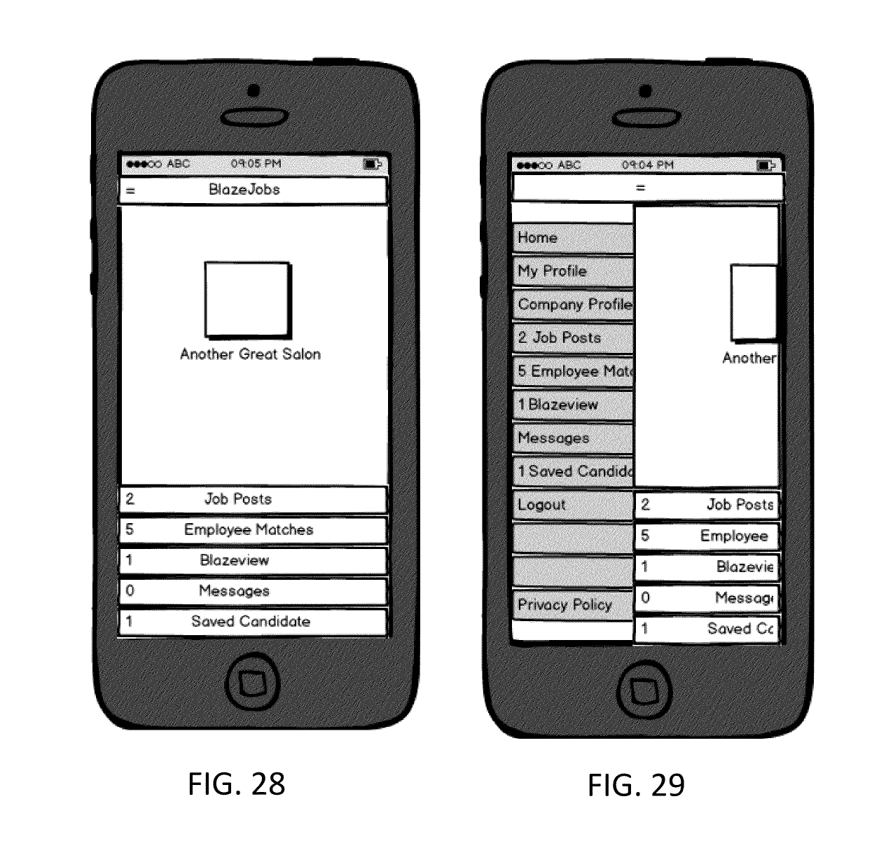

The particular display of such information on the user interface 120 will depend upon the particular function or operation to be accomplished. FIGS. 3-45 generally depict a variety of screens on a mobile device that are preferably used to display and interact with the information related to the operation of the employment matching system 10. Specifically, FIGS. 3-27 depict screens that are preferably used by job seekers searching for jobs, while FIGS. 28-45 depict screens that are preferably used by employers posting jobs and searching for job seekers to fill open positions.

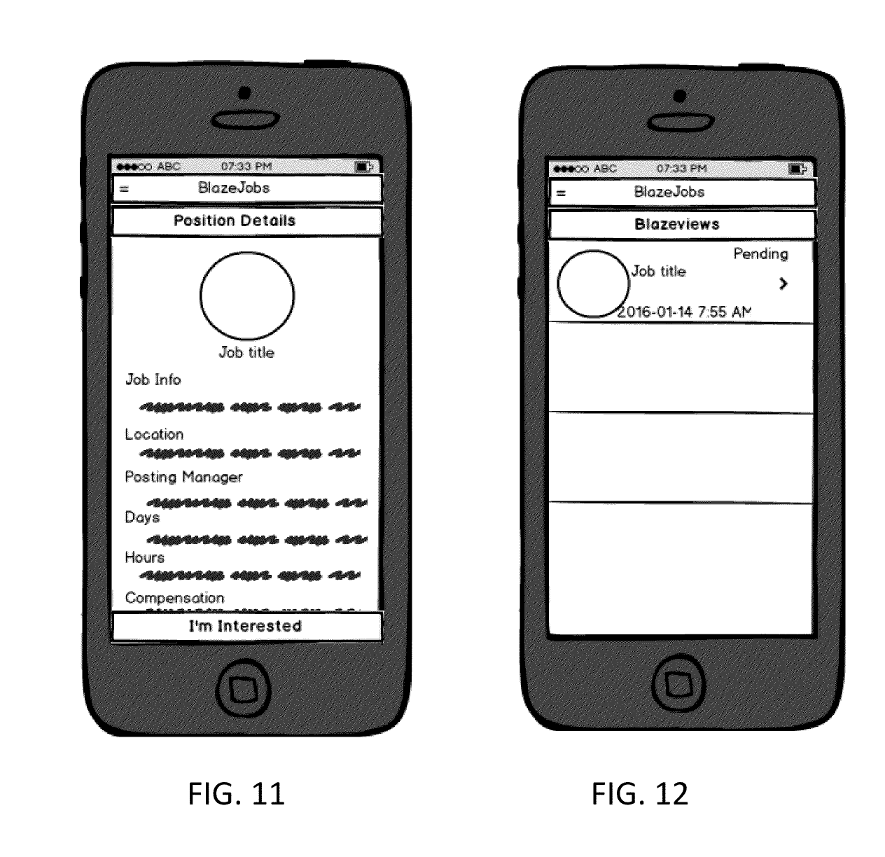

Turning to those screens of particular utility to job seekers, FIG. 3 displays a Home screen for a job seeker. The Home screen allows the job seeker to view job matches within a specified distance of the job seeker's location on a map. The Home screen further allows the job seeker to select a job post presented on the home screen list or the pin drop on the map, which then displays the Position Details screen of FIG. 11, discussed in more detail below.

FIG. 4 displays a Navigation Bar screen. The Navigation Bar screen allows the job seeker to access the Home Screen, the My Profile Screen, the Job Experience screen, the Job Matches screen, the Video interview screen, the Messages screen, the Favorites screen, the Vouches screen, and the Search Settings screen. The job seeker may also logout on the Navigation Screen.

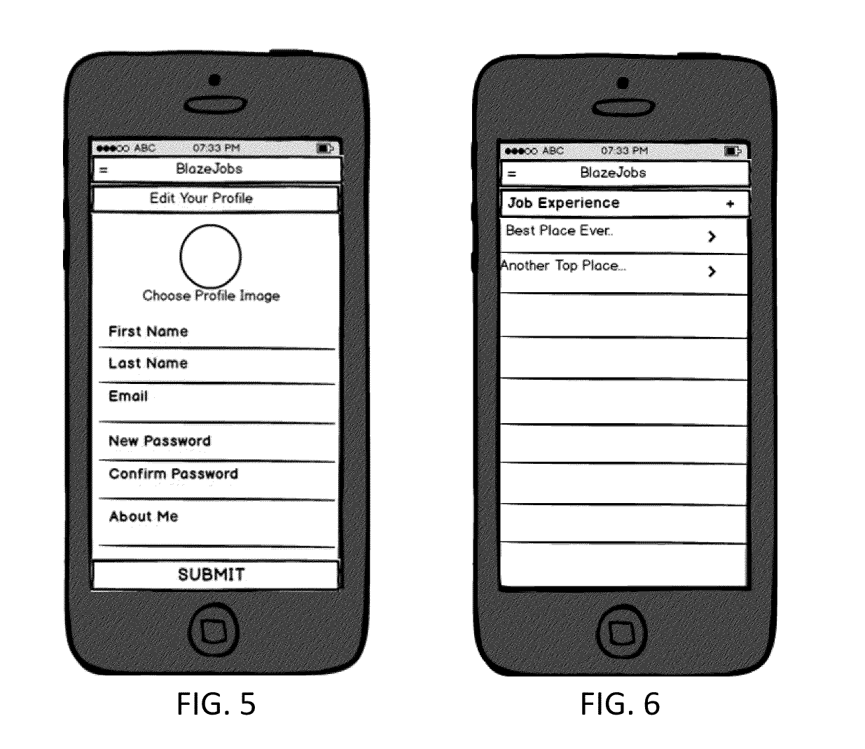

FIG. 5 shows an Edit Profile screen that allows the job seeker to add or edit the job seeker's profile image, name, job title, email, password and new password for changing a password if desired, and about me information. While the embodiment encompassed in FIG. 5 provides for the applicant to add or edit a profile image, alternative embodiments provide for the applicant to add a video into the profile, or select between an image and a video. This information allows the mobile application to provide positions of possible interest to the job seeker in the Job Matches screen. Additionally, some of this information can be viewed by employers who access the job seeker's profile. Once a profile is created by the job seeker, the job seeker's profile screen will allow employers to message the job seeker, save the job seeker, and request a video interview with the job seeker directly or directly video call the job seeker.

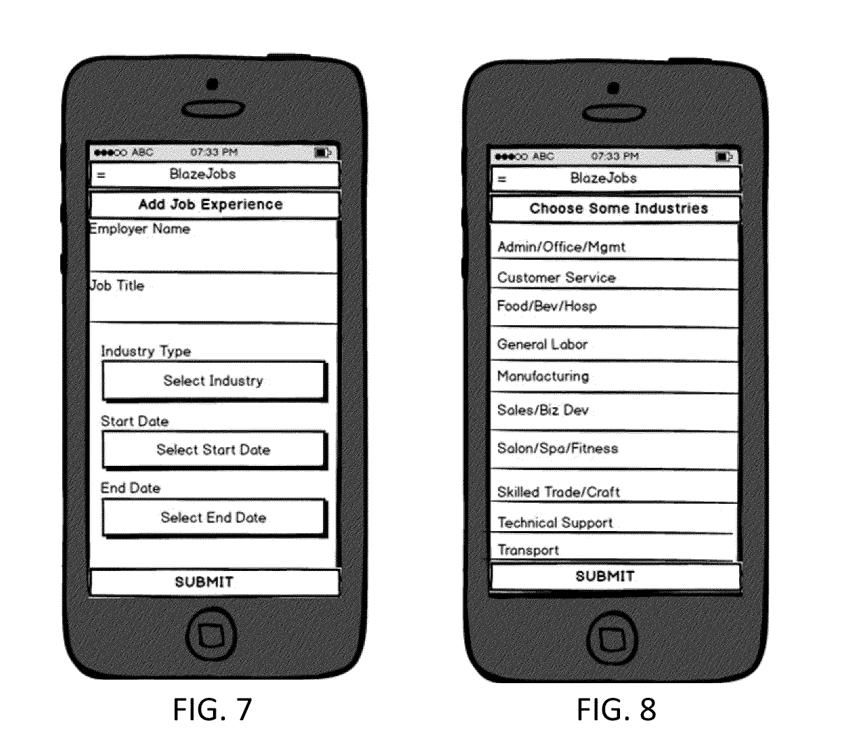

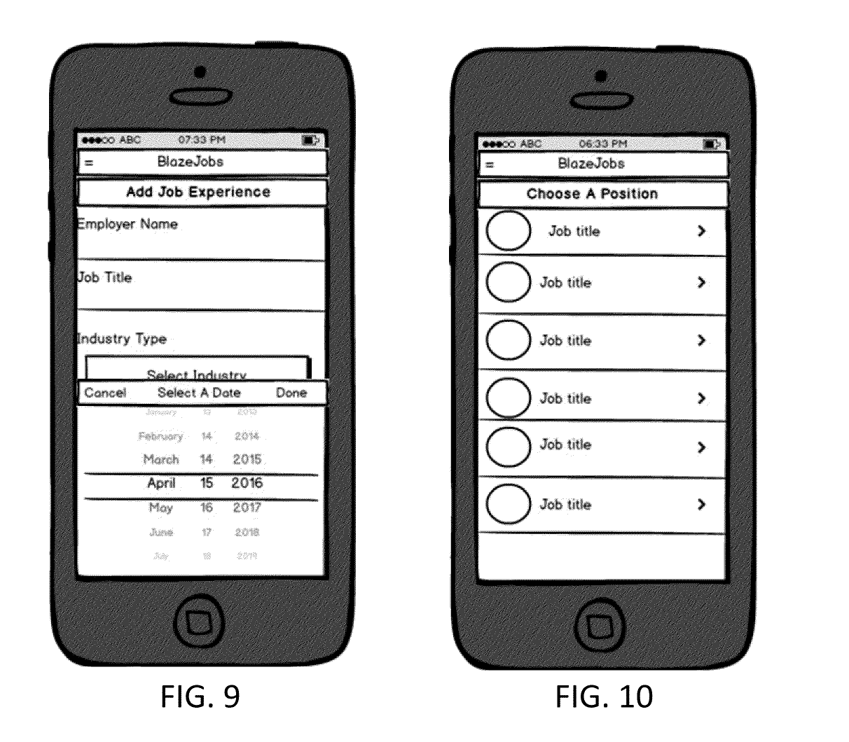

FIG. 6 shows a Job Experience screen that allows the job seeker to input previous job experience. A job seeker may add places of employment by selecting the+ option on the screen. After selecting the+ option to add job experience, the job seeker may input a company name, a job title, the industry related to the employment, and start and end dates, as shown in FIG. 7. Once submitted, the companies where the job seeker has previous experience will be listed on the job experience screen and can be selected and edited if needed. Turning again to FIG. 7, once a job seeker selects the select industry option, the job seeker will be presented with industry options to choose from, as shown in FIG. 8. Similarly, if the job seeker selects the select start date or select end dates options from FIG. 7, a month, day, and year selection tool will be presented, as shown in FIG. 9.

FIG. 10 displays a Job Matches screen. The Job Matches screen displays a list of jobs the mobile application has provided based on criteria provided by the job seeker, such as the information provided in the job seeker's profile and the job seeker's job experience. If the job seeker does not provide information that allows the mobile application to provide suggested positions for the job seeker, the application simply provides positions near the job seeker. If a job seeker is interested in viewing more details about the position, the job seeker may select the position on the Job Matches screen. A Position Details screen will then be provided as shown in FIG. 11. If the job seeker decides he or she is interested in the position, then the job seeker selects the “I'm Interested” option. The employer will then receive a notification containing the job seeker's name and the job post the job seeker is interested in, and the job seeker will be added to the employer's list on the Employee Matches screen. The job will also be added to the job seeker's list of favorites on the Favorites screen, discussed below.

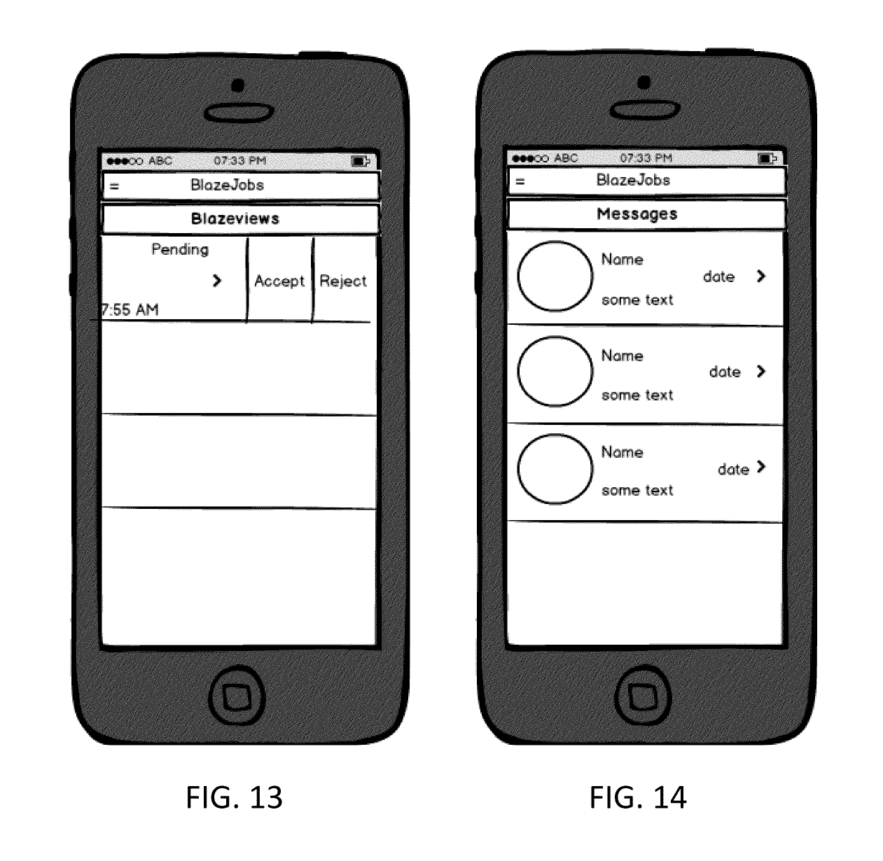

FIGS. 12 shows a Video interviews screen (referred to in the preferred embodiment as “Blazeviews”). Pending and accepted Video interviews sent by employers can be viewed in the job seeker's Video interviews screen. Each pending or accepted Video interview can also be selected in the Video interviews screen. The job seeker will then have the option to accept or reject the pending Video interviews proposed by employers, as shown in FIG. 13. Additionally, the job seeker may cancel accepted Video interviews. The employer sends the Video interview invitation through the employer's Video interview screen, as discussed below. Additionally, the employer's mobile device will receive notifications for video interviews accepted or canceled by the jobseeker. It will be understood that while the preferred embodiment uses the screens depicted in FIGS. 12 & 13 for video interviews, the scheduling and acceptance process could be easily adapted for in-person interviews in an alternative embodiment.

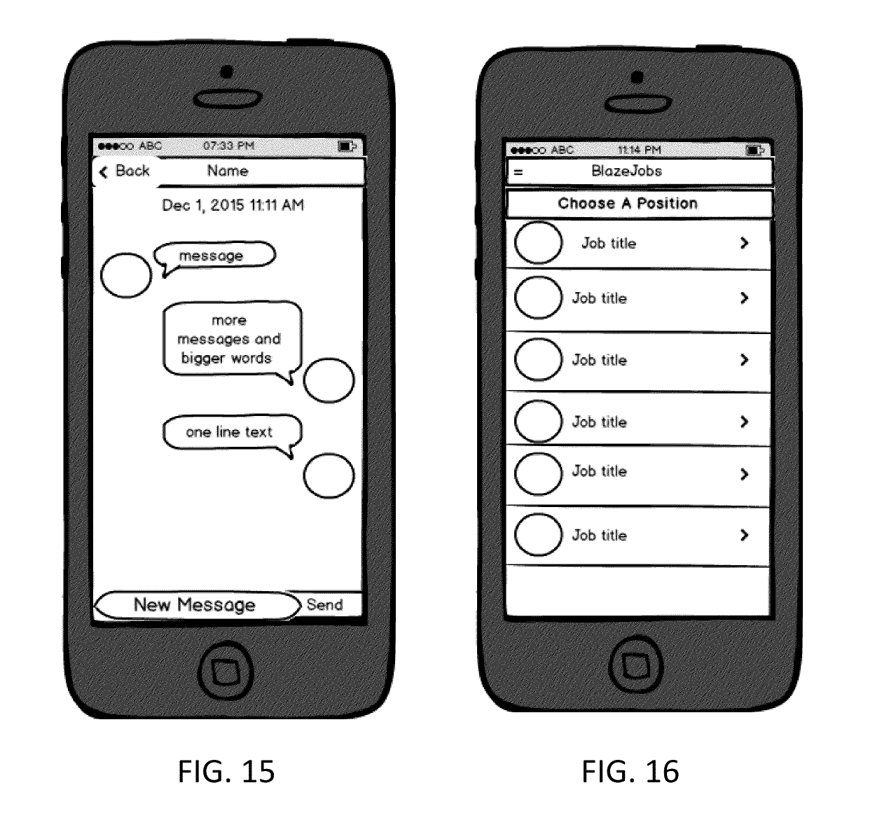

FIG. 14 shows a Messages screen. The Messages screen allows the job seeker to select messages from employers. Once a message is selected, the job seeker may respond to messages from employers, as shown in FIG. 15. The Messages screen shown in FIG. 14 also allows the job seeker to delete messages between the job seeker and the employer or employers. Employers will normally send messages by accessing the Profile screen of the job seeker and selecting the message option, as discussed below. Once an employer sends a job seeker a message, they will receive a notification message on their phone that they have a new message which they can then click and go directly to that message screen, allowing the employer to respond to the message. Similarly to sending messages as shown in FIG. 15, in alternative embodiments, the job seeker may send messages, files, pictures, or videos, and receive notifications and be able to respond in the same manner as discussed above.

FIG. 16 shows a Favorites screen. This screen lists a view of the candidate's favorite job posts. A candidate can favorite any job post by accessing the employer's individual job posting through the Home Screen or the Job Matches screen and selecting the “I'm Interested” option.

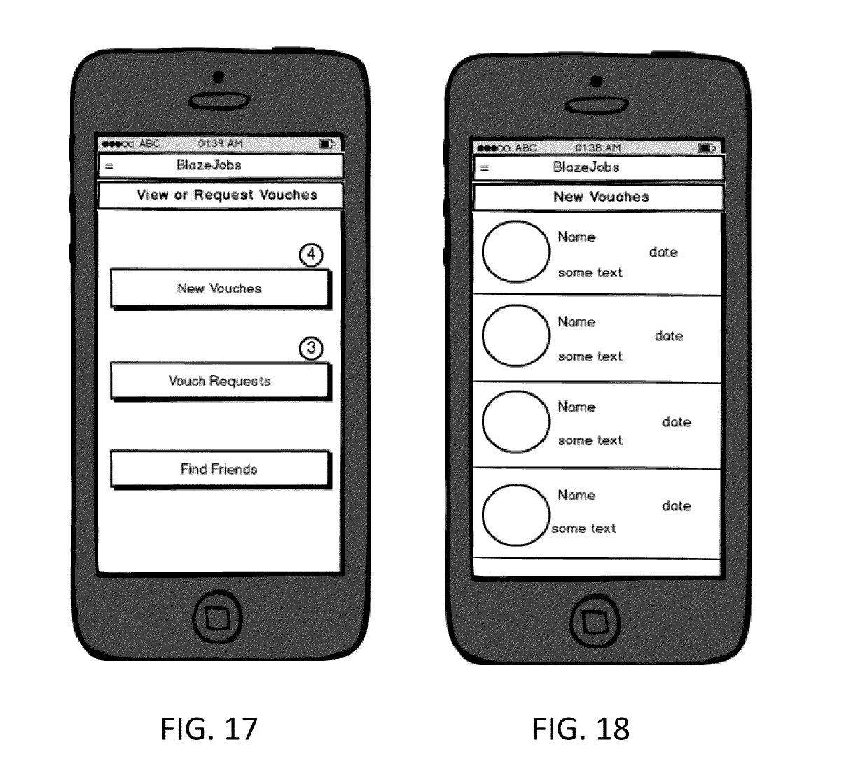

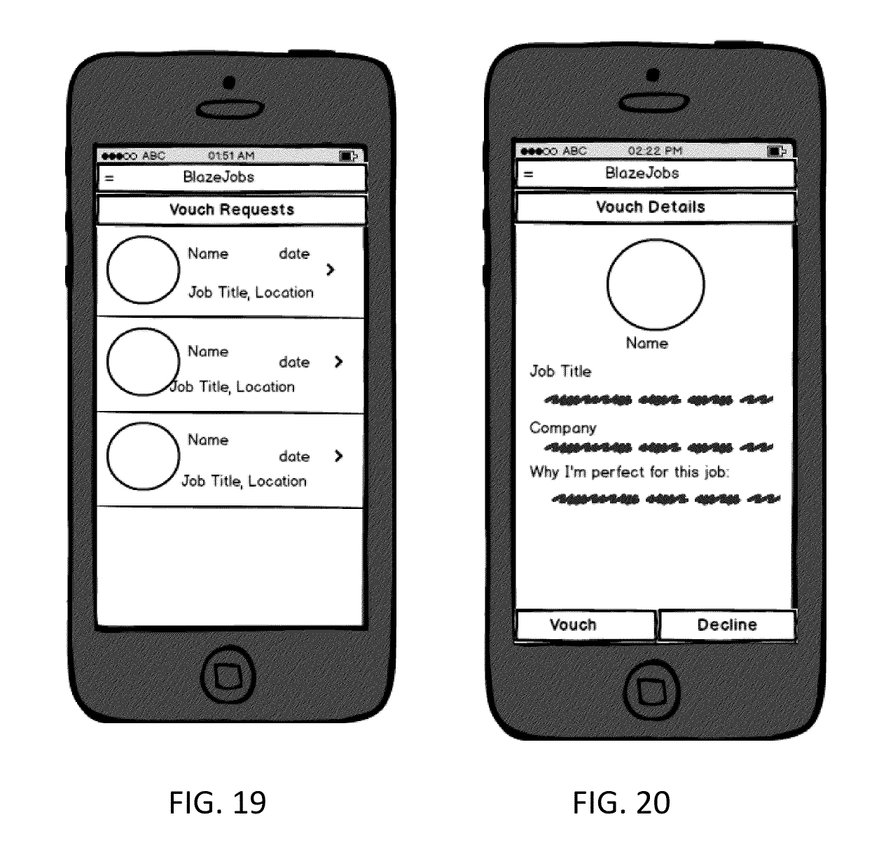

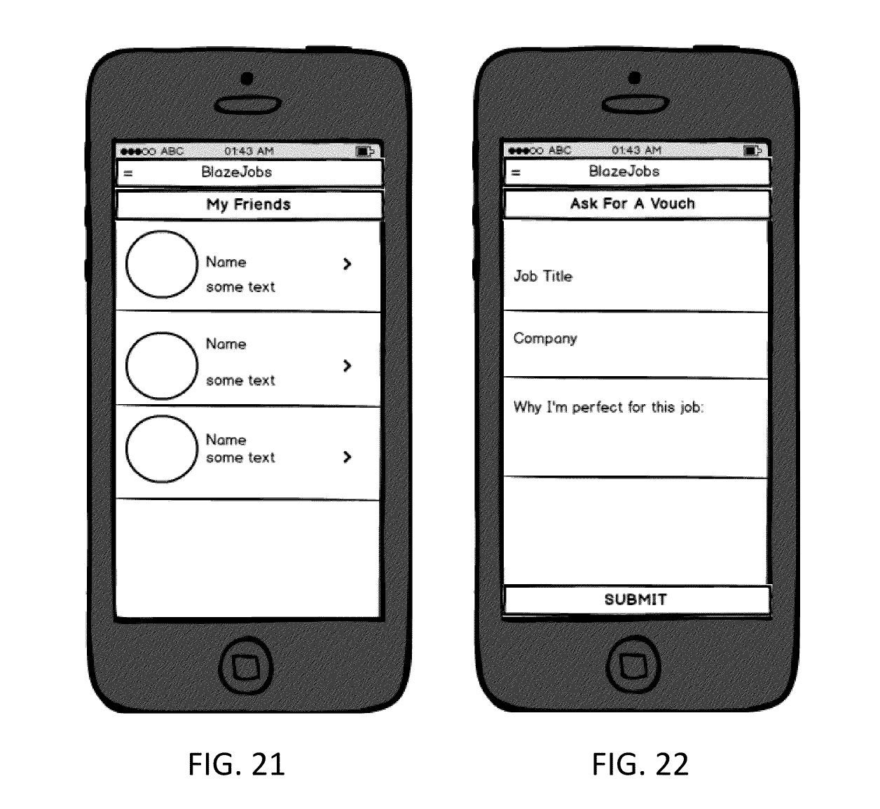

FIG. 17 displays a View or Request Vouches screen. A vouch operates a recommendation, endorsement or reference for the job seeker. This screen allows the job seeker to view the number of new vouches and vouch requests the job seeker has since the job seeker last checked his or her new vouches. Additionally, the Request Vouches screen allows the job seeker to find friends. When the New Vouches option is selected on the View or Request Vouches screen, the application will display a New Vouches screen with information related to the vouch, such as the name of the person who has vouched for the job seeker, the date, and some text derived from the job seeker's about me section of the job seeker's profile, as shown in FIG. 18. When the Vouch Requests option is selected on the View or Request Vouches screen, the application will display the Vouch Requests screen, as shown in FIG. 19. The Vouch Request screen shows the friends of the job seeker who have requested a vouch from the job seeker. Details such as the friend's name, the date of the vouch request, and the job title and location are visible to the job seeker in the Vouch Requests screen. A job seeker may select a vouch request in the Vouch Request screen, which will result in the application displaying a Vouch Details screen, as shown in FIG. 20. The Vouch Details screen allows the job seeker to view details associated with the friend's vouch request, such as the friend's name, the friend's profile video or picture, the job title of the position the friend is applying for, the company responsible for posting the position, and the friend's reasoning for why he or she is a good fit for the position. The job seeker can then decide whether to vouch for the friend, decline the vouch requests, or leave the vouch pending by leaving the Vouch Details screen. When the find friends option is selected on the Request Vouches screen, the application will display the My Friends screen, as shown in FIG. 21. The My Friends screen will display the name of the job seeker's friend and some text derived from the job seeker's about me section of the job seeker's profile. The job seeker's friends are other job seekers who are friends with the job seeker on a social media site, such as facebook, instagram, or twitter. The application automatically inserts friends into the job seeker's My Friends screen based on the application's sign-in process, which allows job seekers to sign-in via their social network accounts. The job seeker may choose to select one of the friends provided in the My Friends screen. The application will then display the Ask for a Vouch screen, as shown in FIG. 22. The job seeker will then supply the job title of the position he or she is applying for, the company that posted the position, and why the job seeker believes he or she is a good fit for the position. In an alternative embodiment, when the job seeker selects the job title option or the company that posted the position option, the application will provide the job seeker with choices for each of the options based on the information the job seeker has input or saved in other screens. Once the job seeker is satisfied with the information provided in the Ask for a Vouch screen, the job seeker will hit submit, which will result in the vouch request being sent to the friend's Vouch Request screen.

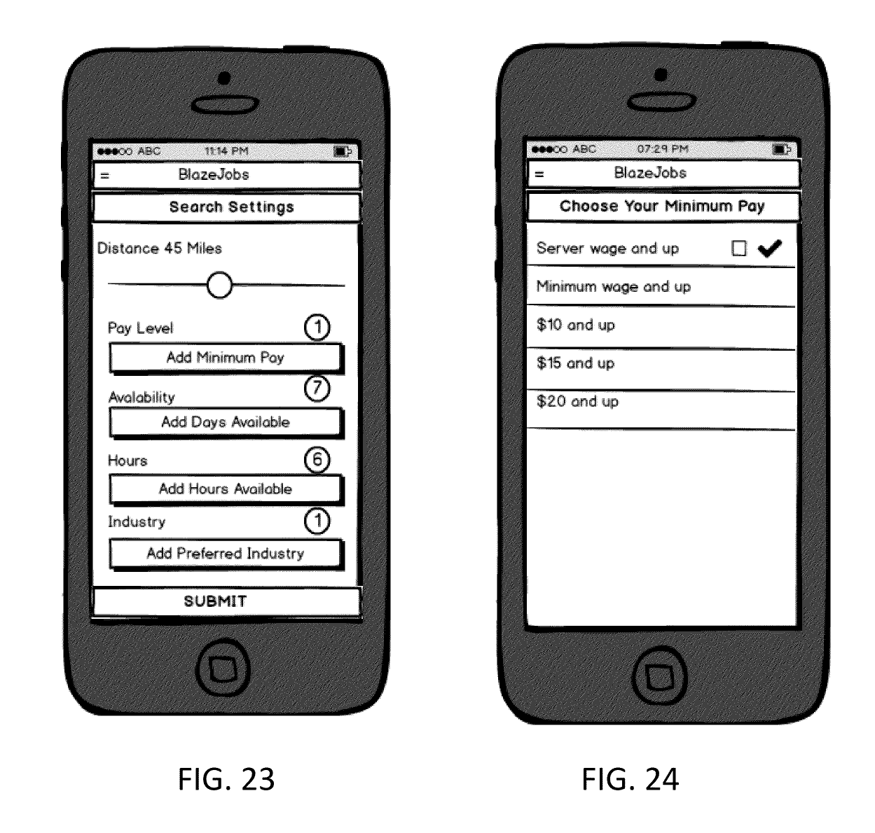

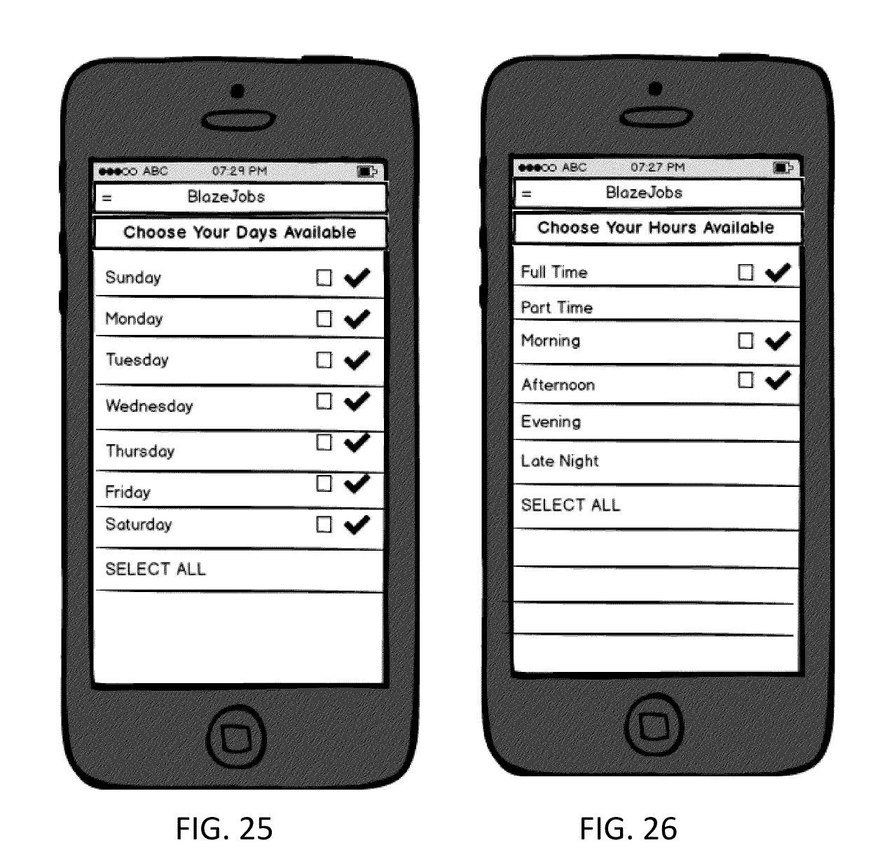

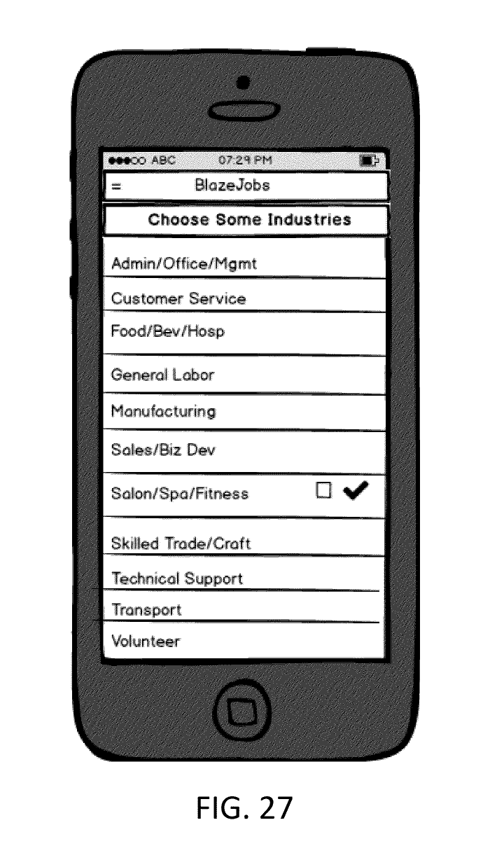

FIGS. 23 shows a Search Settings screen. The search setting screen allows the job seeker to modify criteria while searching for positions. For example, the job seeker may choose to search for positions within a certain distance from the job seeker, or search based on the pay level of the positions, or search based on the day or hours the job seeker is available, or search based on a preferred industry. If the job seeker chooses to create a search based on the position's distance from the job seeker, the distance criteria can be modified by moving the dot along the line, as shown in FIG. 23. If the job seeker desires to search based on pay level, the job seeker can select the add minimum pay option, as shown in FIG. 23, which will result in the job seeker being able to choose from minimum pay criteria that is matched with a direct dollar amount from an employer's job post, as displayed in FIG. 24. If the job seeker desires to search for positions based on daily availability, the job seeker can select the add days available option, as shown in FIG. 23. The job seeker may then choose the days the job seeker is available to work, as shown in FIG. 25. If the job seeker wishes to search for positions based on hours of availability, the job seeker can select the add hours available option, as shown in FIG. 23. The job seeker can then add hourly availability, as shown in FIG. 26. Furthermore, if a job seeker wishes to search for positions in a certain industry or industries, the job seeker may select the add preferred industry option, as shown in FIG. 23. The job seeker may then select from industries, as shown in FIG. 27. Any of the search settings may be used separately or with any of the other search settings. Additionally, once criteria is selected by Applicant by procedures displayed in FIG. 24, 25, 26, or 27, the job seeker will select the back option or swipe the mobile device screen, which will take the job seeker back to the Search Settings screen, as shown in FIG. 23, where the job seeker may select or modify other criteria, or submit the criteria. If the job seeker submits the criteria, the mobile application will provide the job seeker with the jobs matching the criteria. The jobs will be available in the job seeker's Job Matches screen and Home Screen.

Turning now to the version of the mobile application for use by employers, FIG. 28 displays a Home screen. The Home screen allows the employer to access the Job Posts screen, the Employee Matches Screen, the Video interview screen, the Messages screen, and the Saved Job seekers screen.

FIG. 29 displays a Navigation Bar screen that allows the employer to access the My

Profile screen, the Company Profile screen, the Job Posts Screen, the Employee Matches screen, the Video interviews screen, the Messages screen, and the Saved Job seekers screen. The employer also has the option to logout on the Navigation Bar screen.

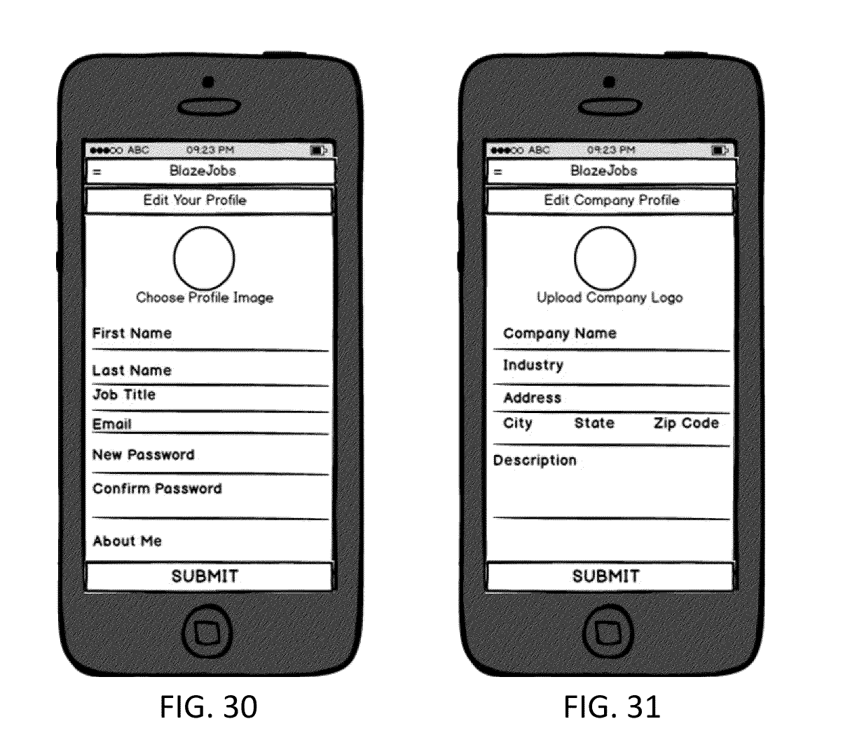

FIG. 30 displays an Edit Profile screen. This screen allows an employer to add or edit the employer's profile image, name, job title, email, password, or about me information. While FIG. 30 shows an option for a profile image, alternative embodiments allow for the employer to use a video instead of an image, or choose between a video and an image.

FIG. 31 displays an Edit Company Profile screen. When this screen is accessed, company information, such as a company logo, name, industry, location, description, and perks of the company, can be added or edited. While FIG. 31 shows an option for a profile image, alternative embodiments allow for the employer to use a video instead of an image, or choose between a video and an image.

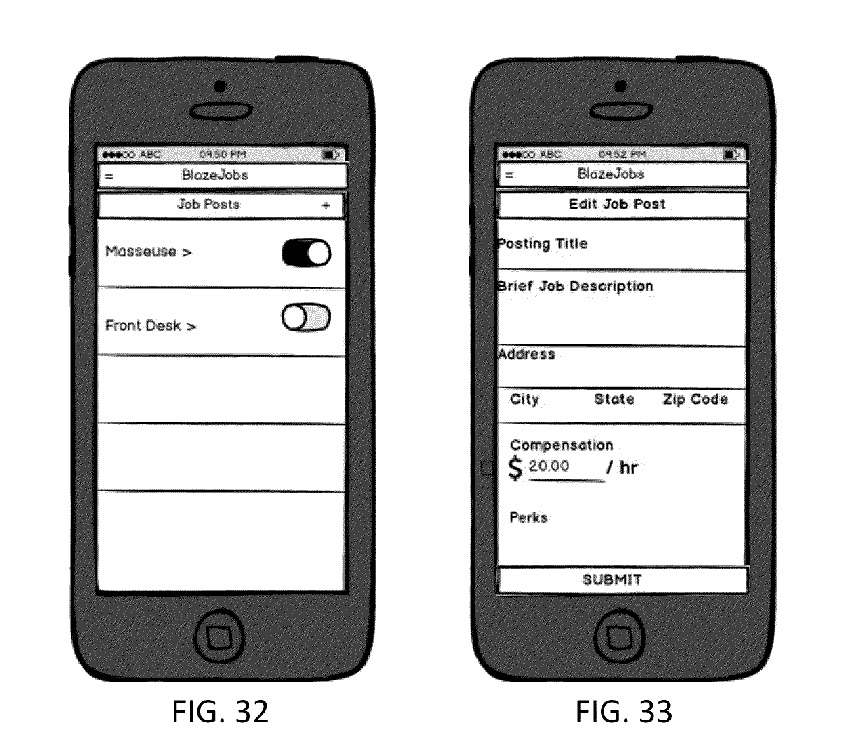

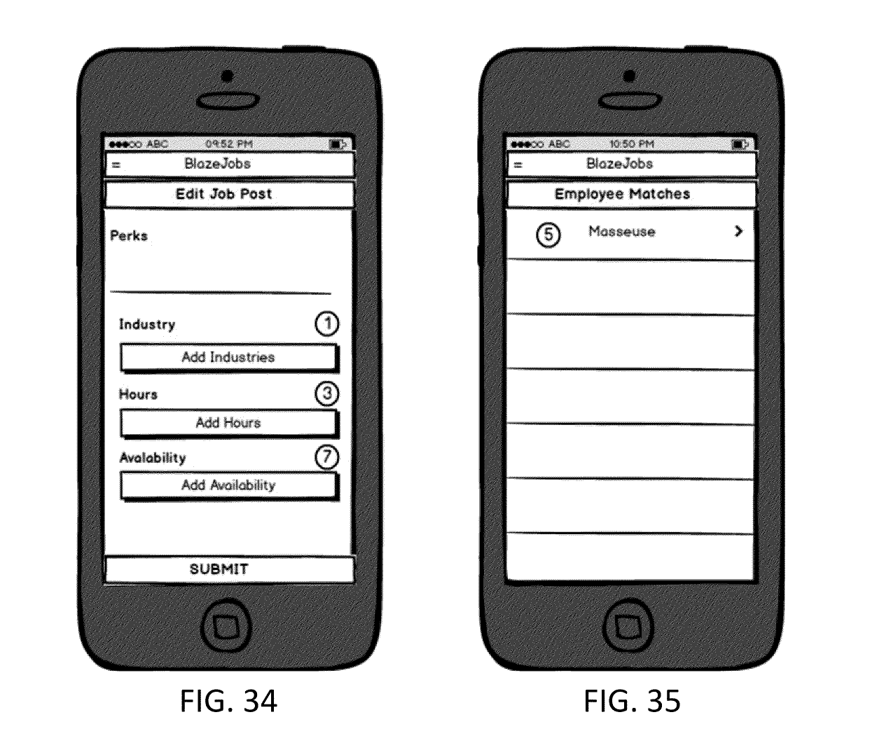

FIG. 32 shows a Job Posts screen. This screen allows the employer to add, edit, or delete job posts. The employer can create new job posts by selecting the+ on the Job Posts screen. If the+ option is selected, the location of the job will automatically be uploaded but may be changed by the employer if desired. The employer will then provide information such as the posting title, a brief description of the job, the compensation of the job, the perks of the job, the industry of the job, and the hours of availability required for the job, as shown in FIGS. 33 and 34. Once the employer adds such information, the employer can hit submit, which will add the job post to the Job Posts screen. Additionally, all jobs posts created by the employer can be turned active and available for job seekers to view, or not active and unavailable for job seekers to view, as shown in FIG. 32. Job posts may be modified by accessing the Job Posts screen and selecting the job post to be edited, which will display a screen similar to FIG. 32.

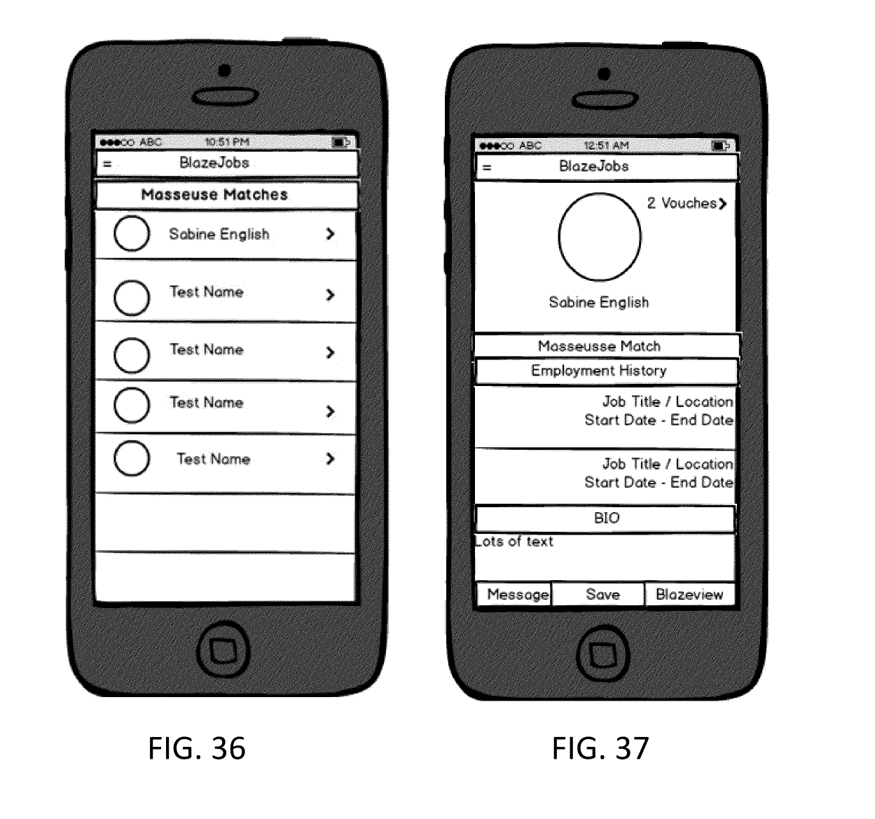

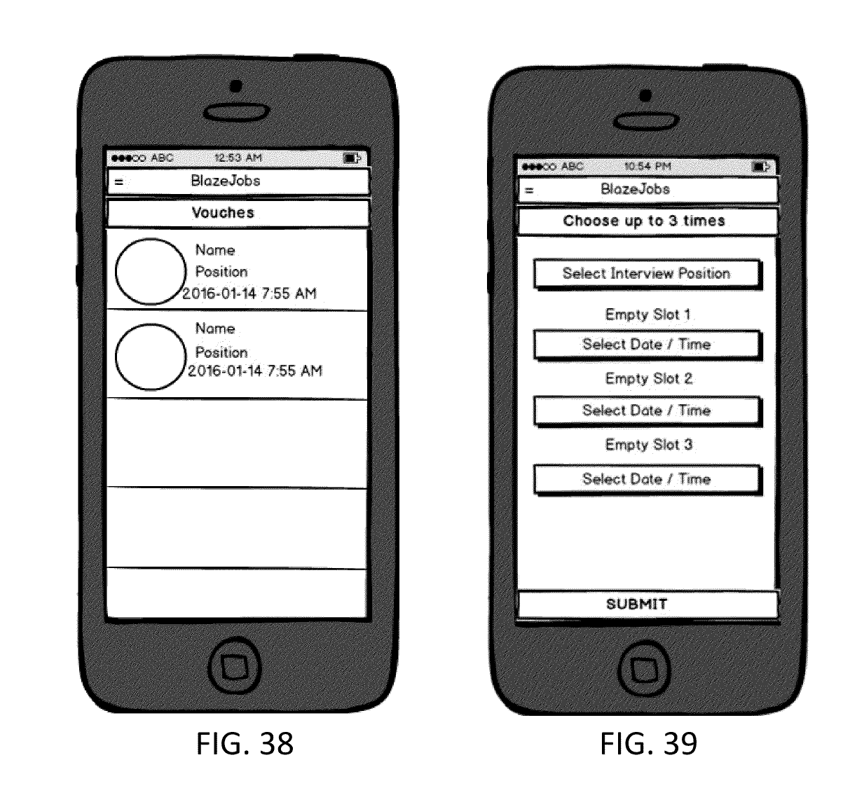

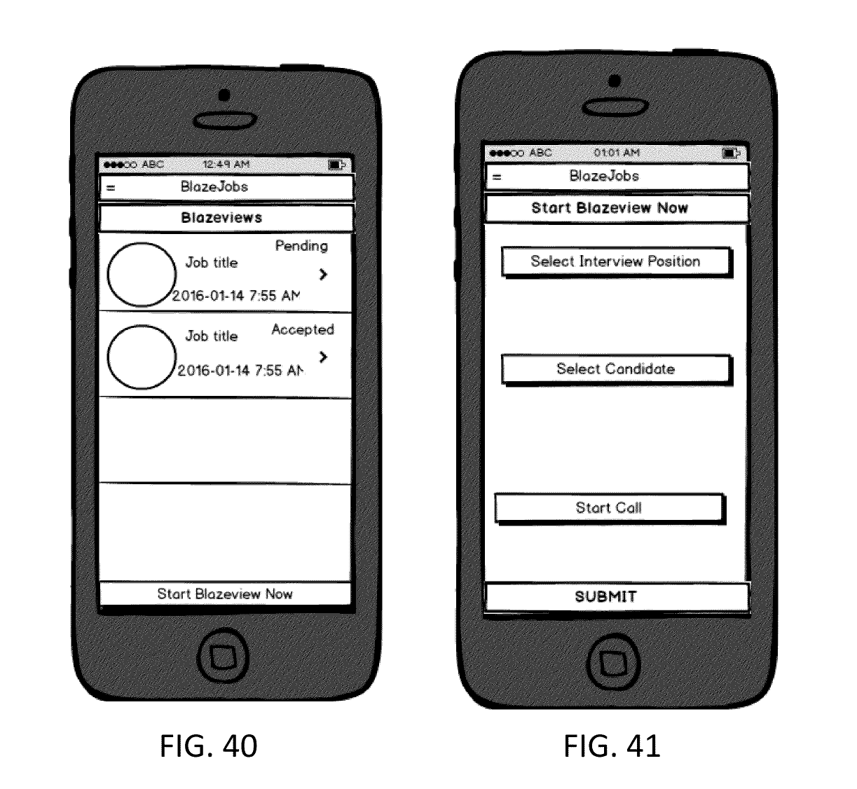

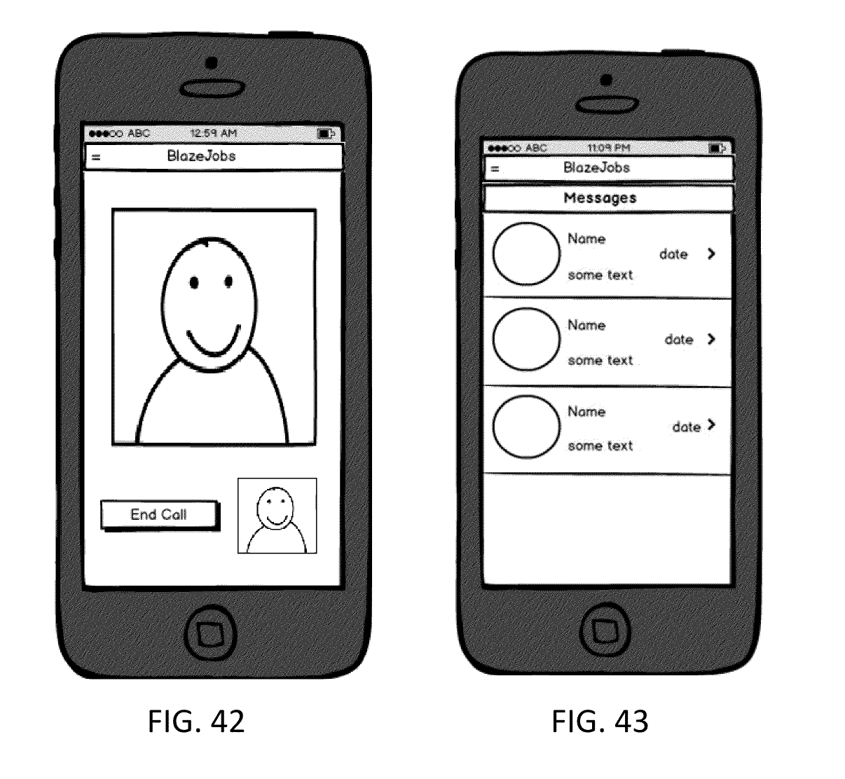

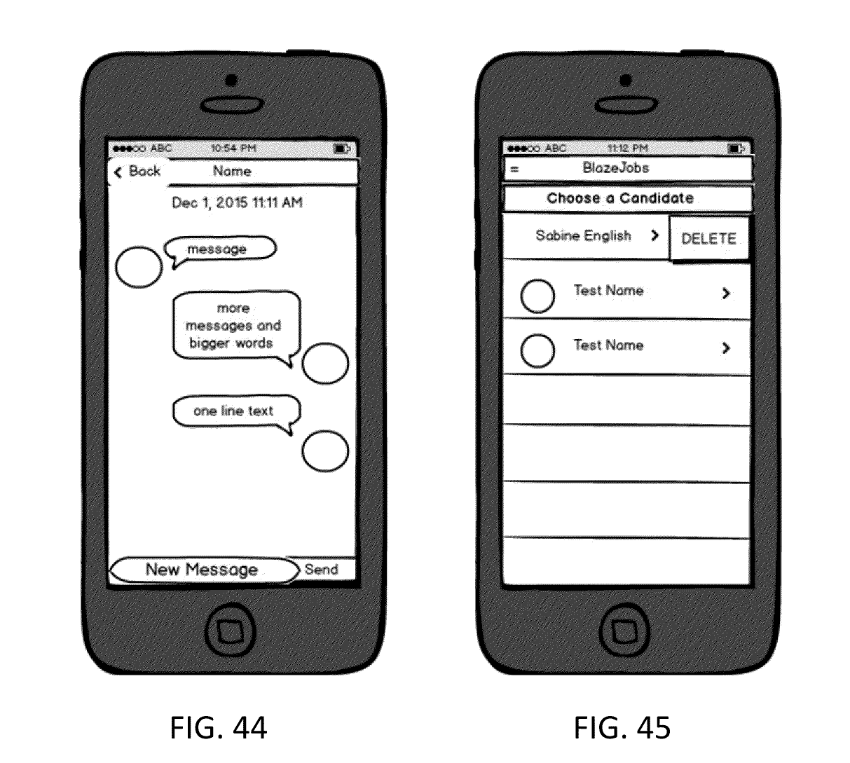

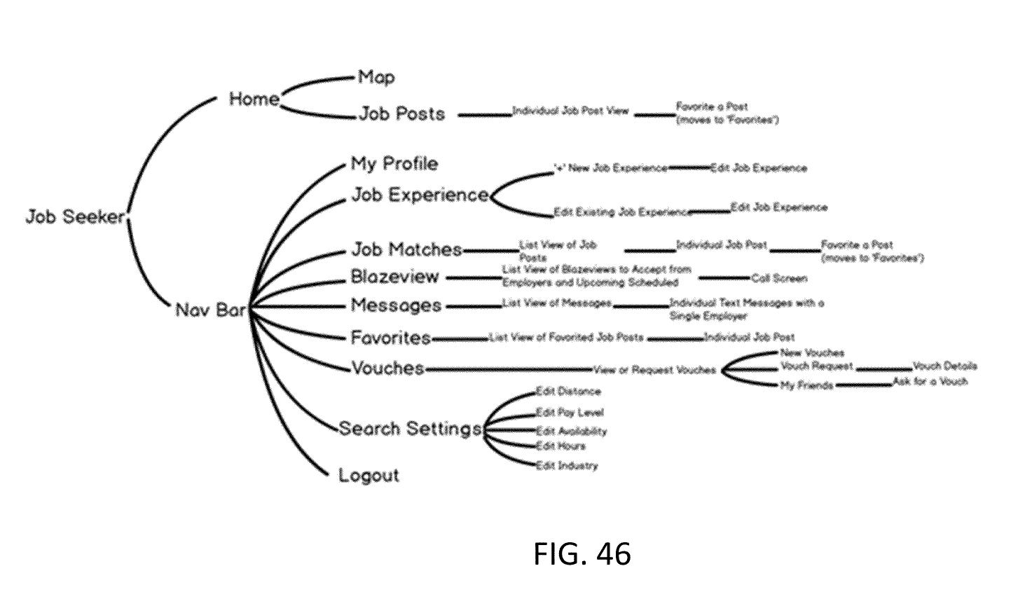

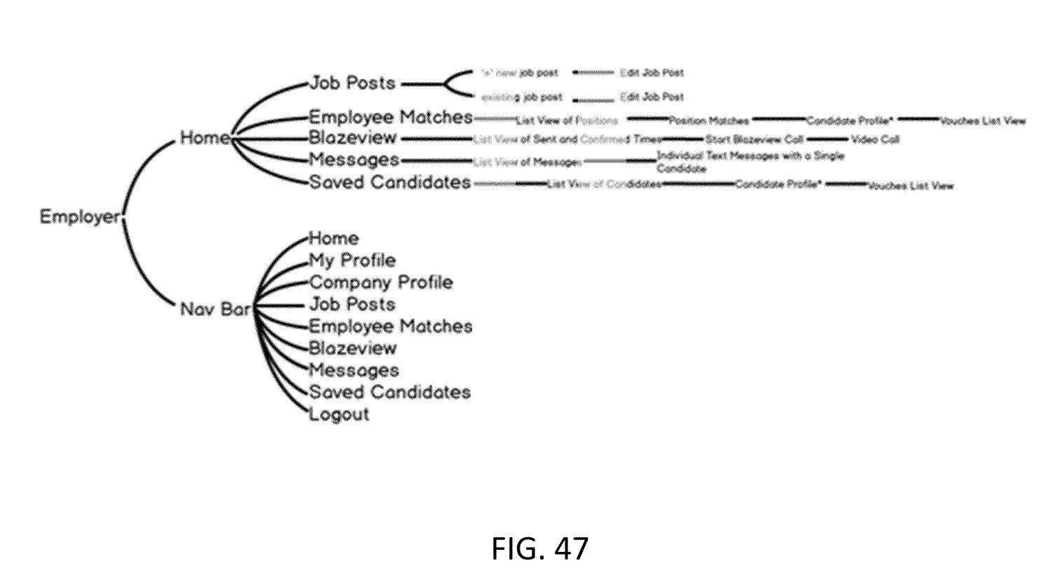

FIG. 35 shows an Employee Matches screen. The Employee Matches screen allows the employer to view the employer's list of jobs posts and job seekers matched to each post. The job seekers matched to each post are the job seekers who have expressed interest through the Job Posts Screen and job seekers that the system's database has provided base on the job seeker's job experience and searching data. The employer can then view a list of job seekers as shown in FIG. 36. If a job seeker in the list interest the employer, then the employer can select the job seeker. If a job seeker is selected, the employer will view the job seeker's Profile screen, as shown in FIG. 37. This screen displays the job seeker's image or video, any vouches the job seeker may have for the employer's posted position, the posted position match with the job seeker, the job seeker's employment history, and the bio of the job seeker. From this profile screen, the employer may message, save the job seeker to employer's favorites, or video interview the job seeker. Further, the employer may select the Vouches option, if the job seeker has vouches, and the application will display the vouches for the job seeker, as shown in FIG. 38. In alternative embodiments, the employer may select the persons listed on the vouches and the application will allow the employer to view the profile of the person who provided the voucher. An employer-created Video interview allows the employer to send the job seeker potential interview times for a specific position within the employer's company, as shown in FIG. 39.

FIG. 40 displays a Video interviews screen. This screen allows the employer to view or cancel upcoming Video interviews a job seeker has accepted, or to view or cancel the Video interviews the employer has proposed to job seekers. Additionally, the employer may choose the Start a Video interview Now option on the Video interviews screen, which will result in the mobile application displaying the Start Video interview Now screen, as shown in FIG. 41. Once in the Start Video interview Now screen, the employer may select the Select Interview Position option, the Select Job seeker option, the Start Call option, or the Submit option. In an alternative embodiment, once the employer selects the Select Interview Position option or the Select Job seeker option, the employer will be provided with choices based on information previously entered by the employer in other screens and job seekers who have accepted proposed video interview times. Once the employer has provided the interview position and the name of the job seeker, the employer may select the Submit option or the Start Call option. If the employer selects the Start Call option, a direct video call will be initiated between the employer and the job seeker. If the employer selects the Submit option, an immediate notification will be sent to the job seeker's mobile device alerting the job seeker that the employer is ready for a video call. Once the employer and job seeker are connected, the employer will view the job seeker via live video, as shown in FIG. 42. In alternative embodiments, the video call could be a standard phone call. Additionally, in alternative embodiments, the Video interview screen will allow for the employer to suggest in-person interviews with proposed times and locations or video interviews with proposed times.

FIG. 43 is a Messages screen. This screen allows the employer to view a list of all messages. If an employer selects a particular message, the employer can message an individual job seeker, as shown in FIG. 44. The Message screen also allows the employer to delete messages between the employer and individual job seekers. The first messages in a message conversation are initiated from the job seeker's Profile Screen, and then future messages and the rest of the messaging conversation is made available in the Messaging screen. Similarly to sending messages as shown in FIG. 44, in alternative embodiments, the job seeker may send messages, files, pictures, or videos, and receive notifications and be able to respond in the same manner as discussed above.

FIG. 45 displays a Saved Job Seekers screen that allows the employer to view a list of the employer's saved job seekers. The employer can then select a job seeker to view the job seeker's profile. Once the employer has accessed the job seeker's profile, the employer can message the job seeker, create a video interview, or view vouches, as discussed above. The employer may also delete the job seeker's profile from employer's saved job seekers list of the Saved Job Seekers screen.

FIG. 46 is a flow chart displaying the job seeker's navigation through the application's screens as described above. FIG. 46 additionally illustrates the methods for which information from one screen may be transferred to another screen. For example, the job seeker may login and be presented with the Home screen—if a job seeker has not set up a profile he she will be presented with the My Profile screen; otherwise the job seeker is presented with the Home screen. Once on the Home Screen, the job seeker can view a map with pins for job posts listed on the Home Screen. The job seeker may choose one of the job posts on the lists or select a pin on the map and be presented with an individual Job Post view. Once in the Job Post view, the job seeker may favorite a Job Post, which will move that post to the Favorites screen. In an alternative embodiment, the job seeker may select a job post from the list and be presented with a pin on the map displaying the job's location. The Navigation screen functions the same way as the Home screen for searching. In order to access the Navigation screen Bar, the job seeker can swipe the screen on his or her mobile device. Once the screen is swiped, the Navigation Bar screen will be presented with options to select the My Profile screen, the Job Experience screen, the Job Matches screen, the Video interview screen, the Messages screen, the Favorites screen, the Vouches screen, the Search Settings screen, and a Logout option. The job seeker can then move through screens as discussed above regarding the Home screen. The job seeker may return to the previous screen by selecting the back option or swiping on the screen of the job seeker's mobile device.

FIG. 47 is a flow chart displaying the employer's navigation through the mobile application's screens as described above. The employer's navigation functions in the same manner as the job seeker's navigation, as discussed above. The employer may return to the previous screen by selecting the back option or swiping on the screen of the employer's mobile device.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

It is claimed:

1. A system for identifying employment positions, the system comprising:
a first mobile device comprising:
a first processor;
a first user interface in communication with the first processor;
a first data storage medium having a first set of executable instructions, the first executable instructions configured to direct the first processor to display a first plurality of screens on the first user interface; and
wherein the first plurality of screens are configured for the entry of a company profile and a job post having a first location; and
a second mobile device comprising;
a second processor;
a location detection module in communication with the second processor and configured to determine a second location of the second mobile device;
a second user interface in communication with the second processor;
a second data storage medium having a second set of executable instructions, the second executable instructions configured to direct the second processor to display a second plurality of screens on the second user interface;
wherein the second plurality of screens are configured for:
the display of the company profile and the job post;
the entry of a candidate profile having prior job experience; and
the submission of a notification to the first mobile device indicating interest in the job post.

2. The system of claim 1, wherein the second plurality of screens are configured for the display of a plurality of job posts which are sorted based on the distance between the second location and the location of each of the job posts in the plurality of job posts.

3. The system of claim 2 further comprising:
a third mobile device comprising:
a third processor;
a third user interface in communication with the third processor;
a third data storage medium having a third set of executable instructions, the third executable instructions configured to direct the third processor to display a third plurality of screens on the third user interface; and
wherein the third plurality of screens are configured for the submission of a notification to the first mobile device indicating endorsement of the candidate profile.

4. A mobile device, comprising:
a first mobile device comprising:
a first processor;
a first user interface in communication with the first processor;
a first data storage medium having a first set of executable instructions, the first executable instructions configured to direct the first processor to display a first plurality of screens on the first user interface; and
wherein the first plurality of screens are configured for:
the display of the company profile and the job post;
the entry of a company profile, a job post having a first location, and a first candidate profile having prior job experience;
the submission of a notification that indicates interest in the job post; and
the submission of a notification that indicates endorsement of a second candidate profile.
